(19) United States
(12) Patent Application Publication
(10) Pub. No.: US 2015/0308726 A1
(43) Pub. Date: Oct. 29, 2015

(54) METHOD AND APPARATUS FOR RECOVERING CRYOGENS

(71) Applicant: Brian King, Godalming (GB)

(72) Inventor: Brian King, Godalming (GB)

(21) Appl. No.: 14/260,370

(22) Filed: Apr. 24, 2014

(51) Int. Cl. F25D 3/11; A23B 4/09

(52) U.S. Cl. CPC F25D 3/11; A23B 4/09; A23V 2002/00

(57) ABSTRACT

An apparatus and method for recovering a cryogenic fluid used to freeze a food item in a food freezer. The cryogenic fluid is sprayed onto the food item such as a bird carcass and when there is excess cryogenic fluid, it is captured in a cryogen drain basin situated at the bottom of the food freezer. The cryogenic fluid is fed to a pump which will pump the cryogenic fluid to a spray assembly which will spray the cryogenic fluid in its gaseous or liquid form into the food freezer or else to alternative chilling, cooling or inerting processes

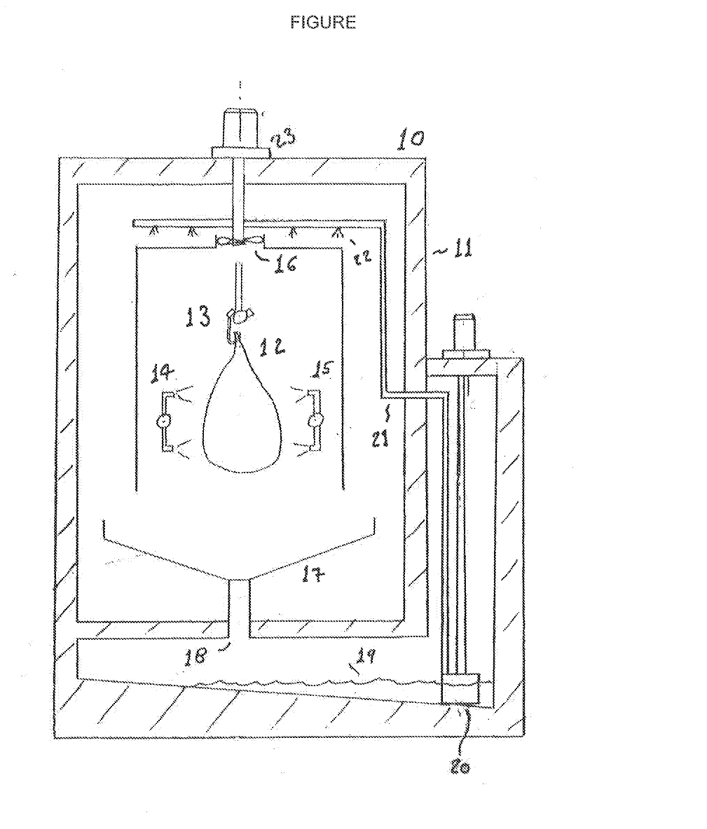

### BACKGROUND OF THE INVENTION

The invention relates to a method and an apparatus for recovering cryogenic fluids used in food treatment operations.

Methods are available to cryogenically treat food items such a bird carcasses. Some of the benefits of cryogenic cooling and freezing include short cooling/freezing times, inhibition of microbiological activity and improved food quality due to decreased ice crystal formation and dehydration. The most common methods for cryogenic freezing involve spraying the surface of the food items with nitrogen (N₂) or carbon dioxide (CO₂). In N₂ systems, liquid N₂ is typically sprayed into the freezer where it contacts the food items. As droplets touch the food item the liquid changes to a vapor thereby extracting heat from the food surface in the process. The vapor distributed within the freezer can also be driven by convective currents to increase the freezing or cooling rate. Typically, about half of the cooling effect is provided by the N₂ phase change from liquid to vapor.

Different types of cryogenic freezers are available. These include immersion freezers, tunnel and spiral freezers, and impingement freezers. Immersion freezers immerse the food item in a liquid bath, which rapidly freezes the item and forms a “crust” on the product which reduces the dehydration rate and clumping of the food item. This method leads to significant thermal shock and is thus not suitable for delicate food items. Tunnel freezers transport the product through the freezer where a liquid cryogenic substance is sprayed onto the product. Spiral freezers are similar, except that they use a vertical axis spiral belt rather than a straight belt to convey the food items, and therefore require less space on a production floor. Cryogenic impingement freezers use high velocity air jets driven onto the food item to freeze or cool the food items and decrease the boundary layer resistance to heat transfer, providing a relatively higher rate of heat transfer. However, conventional impingement jets only reach maximum velocities of about 20 meters per second. Cryogenic impingement freezers typically lead to higher production rates, but have a higher capital cost.

In tunnel freezers, when treating bird carcasses using a cryogen, the cryogen is sprayed into equipment, such as a food freezing tunnel at a rate based on the heat load within the equipment. While this is usually pretty accurate theoretically, any variance in the heat load of the bird carcasses will result in an in-balance of cryogen entering the tunnel.

As such, there will be an excess of cryogen that will be deposited at the bottom of the food freezer. The invention provides for the collection of this excess cryogenic fluid and pumping it back into open spaces in the equipment or re-use elsewhere. The cryogenic fluid will transition into its gas phase and these gas molecules can be withdrawn from the food freezer through the exhaust systems.

### SUMMARY OF THE INVENTION

The invention provides several advantages over systems that do not recover the cryogenic fluid. One such advantage is the ability to recover and reuse the excess cryogen In the operators factory to, for example, chill the chickens upstream of the tunnel or use the gas for alternative purposes. Likewise, there will be a recovery of the cold within the cryogenic fluid which can be used to further cool the equipment or food items and the economic advantages this recovery entails. This recovery provides for a safe use of the cryogenic fluid. Further, there are advantages in recognizing that a constant heat load is not always going to be maintained in a food freezer and there is no reason to stop the production process when there is spilt cryogenic fluid.

In one embodiment of the invention, there is disclosed a method for recovering a cryogenic fluid from a food freezer comprising spraying the cryogenic fluid onto a food item, capturing the cryogenic fluid in the food freezer, feeding the cryogenic fluid to a pump, pumping the cryogenic fluid to a spray assembly and reusing the cryogenic fluid.

The reuse of the cryogenic fluid may be inside the food freezer. Alternatively, the reuse of the cryogenic fluid could be in components or equipment outside of the food freezer such as upstream of the food freezer. The intent herein is to recover the cryogenic fluid to recover the cooling and inert properties of the liquid cryogen.

The food freezer is typically a tunnel food freezer where the cryogenic fluid is sprayed onto the food item. The cryogenic fluid is typically nitrogen. The food item is typically a bird carcass such as a turkey or chicken carcass.

The cryogenic fluid is captured in a bottom portion or section of the food freezer where it will be in fluid communication with the pump. The pump is a specialist type capable of pumping liquid nitrogen continuously or intermittently.

The amount of cryogenic fluid recovered is usually in an amount that exceeds the calculated amount necessary to freeze the food item.

The cryogenic fluid that is recovered can alternatively be pumped to a tank or vaporizer or other storage vessel for reuse in the food freezer or elsewhere in the customer's site including processing of the birds.

In another embodiment of the invention, there is disclosed an apparatus for recovering a cryogenic fluid comprising a food freezer, a cryogen drain basin, a pump and a spray assembly.

The cryogen drain basin situated at the bottom of the food freezer is in fluid communication with the pump. The pump in turn is in fluid communication with the spray assembly which typically contains vents for discharging the cryogenic fluid in its gas phase.

### BRIEF DESCRIPTION OF THE DRAWINGS

The FIGURE is a schematic of a food freezing operation showing the cryogenic recovery system of the invention.

### DETAILED DESCRIPTION OF THE INVENTION

Turning to a FIGURE, a food freezer 10 is shown. The food freezer 10 is typically a tunnel food freezer. The food freezer has insulated walls 11 that enclose an open interior. Hanging in the interior is a bird carcass 12 such as a turkey or chicken carcass which is hanging from a hook mechanism 13. The liquid cryogen which can be nitrogen is dispensed through spraying nozzles 14 and 15 and will contact the bird carcass 12. This liquid cryogen is typically at −106° C. degrees in temperature and is sprayed onto the bird carcass 12 in an amount necessary to destroy the bacterial cells (typically campylobacter) on the outside surfaces of the birds. The bird carcasses will travel through the tunnel freezer by the hook mechanism 13 which is attached to a conveyer type assembly at the top of the tunnel food freezer 10. These flows of bird carcasses will be controlled with a programmable logic control (PLC) such that the bird carcass will be positioned within the spraying nozzles 14 and 15 and contact the cryogenic fluid for a time sufficient to cryogenically shock the surface of the bird carcass. A turbulence fan 16 and drive motor 23 can be present at the top of the food freezer to assist in circulating vapor throughout the food freezer. This fan 16 and associated drive motor 23 may or may not be included depending upon the construction of the food freezer.

The objective of the food freezer operator is to balance the spraying of cryogenic fluid with the amount of heat to be removed from the bird carcass so that there is no waste of cryogen. However, it is not unusual for an imbalance to occur and the operator will therefore spray too much cryogenic fluid through spraying nozzles 14 and 15. When this occurs, the cryogenic fluid is captured by the cryogen drain basin 17 which is typically a funnel shaped assembly at the bottom of the tunnel food freezer 10. The cryogen drain basin 17 will have an opening at the bottom 18 through which the cryogenic fluid will flow and gather at the bottom 19 of the tunnel food freezer 10.

Situated at the bottom 19 of the tunnel food freezer 10 is a cryogen pump 20. These cryogen pumps are specialist pumps and capable of pumping liquid nitrogen constantly or intermittently The cryogen pump 20 will sense that a certain level of cryogenic fluid is present in the bottom 19 of the tunnel food freezer 10 and will pump the cryogenic fluid up through line 21 to a spray assembly 22. The cryogenic fluid will warm up during its passage through line 21 and when it arrives at the sprayer assembly 22 will be in the gaseous state and can be sprayed through the vents in the sprayer assembly for dissipation in the tunnel food freezer atmosphere. Heat may also be supplied to the line 21 through an optional heater to ensure that the cryogenic fluid enters the gaseous state before arriving at the sprayer assembly 22. The cryogenic fluid can be recovered and pumped to a tank or storage vessel for reuse. Typically the cryogenic fluid which is usually nitrogen can be used elsewhere in a customer's site to complete other freezing or chilling duties or can be put through a heater or vaporizer to generate gaseous nitrogen for other uses in the customer's facility.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what I claim is:

1. A method for recovering a cryogenic fluid from a food freezer comprising spraying the cryogenic fluid onto a food item, capturing the cryogenic fluid in the food freezer, feeding the cryogenic fluid to a pump, pumping the cryogenic fluid to a spray assembly and reusing the cryogenic fluid.

2. The method as claimed in claim 1 wherein the reuse of the cryogenic fluid is inside the food freezer.

3. The method as claimed in claim 1 wherein the reuse of the cryogenic fluid is in components or equipment outside of the food freezer.

4. The method as claimed in claim 1 wherein the food freezer is a tunnel food freezer.

5. The method as claimed in claim 1 wherein the cryogenic fluid sprayed onto a food item is at a temperature of −196° C.

6. The method as claimed in claim 1 wherein the cryogenic fluid is nitrogen.

7. The method as claimed in claim 1 wherein the food item is a bird carcass.

8. The method as claimed in claim 1 wherein the pump is in fluid communication with the cryogenic fluid.

9. The method as claimed in claim 1 wherein the pump is a cryogenic pump capable of pumping liquid nitrogen constantly or intermittently.

10. The method as claimed in claim 1 wherein the recovering of the cryogenic fluid will recover cooling and inert properties of the liquid cryogen.

11. The method as claimed in claim 1 wherein the cryogenic fluid is captured in a bottom portion of the food freezer.

12. The method as claimed in claim 1 wherein the cryogenic fluid recovered is in an amount that exceeds the amount necessary to cryogenically process the food item.

13. An apparatus for recovering a cryogenic fluid comprising a food freezer, a cryogen drain basin, a pump and a spray assembly.

14. The apparatus as claimed in claim 13 wherein the food freezer is a tunnel food freezer.

15. The apparatus as claimed in claim 13 wherein the cryogenic fluid is selected from the group consisting of nitrogen and carbon dioxide.

16. The apparatus as claimed in claim 13 wherein the cryogen drain basin is situated at the bottom of the food freezer.

17. The apparatus as claimed in claim 13 wherein the cryogenic drain basin is in fluid communication with the pump.

18. The apparatus as claimed in claim 13 wherein the pump is in fluid communication with the spray assembly.

19. The apparatus as claimed in claim 13 wherein the spray assembly contains vents for discharging the cryogenic fluid in its gas phase.

20. The apparatus as claimed in claim 13 where discharge fluid from the freezer is forwarded to other chilling or cooling processes.
